(19) United States
(12) Patent Application Publication
(10) Pub. No.: US 2011/0049315 A1
(43) Pub. Date: Mar. 3, 2011

(54) Fish and Multipurpose Hanger

(76) Inventor: Gary Buckbee, Independence, MO (US)

(21) Appl. No.: 12/868,597

(22) Filed: Aug. 25, 2010

Related U.S. Application Data
(60) Provisional application No. 61/236,933, filed on Aug. 26, 2009.

(51) Int. Cl. F16M 13/02

(52) U.S. Cl. 248/219.4

(57) ABSTRACT

A foldable, portable, lightweight support stand that can be used by hunters and campers to prepare game and hang objects, such as lanterns and trash bags, that must be elevated from the ground. The stand folds down with the removal of one bolt. The folded size is compact enough to fit into a backpack. One strap is used to support the stand from a tree. Two spikes at the base serve to prevent rotation. Magnets at the base of the stand hold tools within arm's reach.

### CROSS REFERENCE TO RELATED APPLICATION

This application claims the benefit of U.S. Provisional Application No. 61/236,933 filed on Aug. 26, 2009, entitled “Fish Hanger”

### BACKGROUND OF THE INVENTION

1. Field of the Invention

The present invention relates to a portable stand for hanging objects, such as fish and small animals, from trees.

2. Description of the Prior Art

U.S. Pat. No. 7,341,507 to Julian discloses a portable game support. The portable game support includes a frame made from horizontal, vertical and diagonal frame members. The horizontal frame member may have a D-ring with an attached pulley to assist in lifting an animal. The frame members may be formed from tubular metal. Further, the frame members include opposite ends with attachment points on the ends. The attachment points are U-shaped connectors which have overlap and compression sections. The compression sections include a connector port, or hole, through the section and the frame member. The connector can be a bolt, washers, a nut, or a bolt and a cotter pin. The frame disclosed herein is supported against a vertical object through a pair of horizontal support straps having a first and a second opposite ends. The Julian support, while both portable and foldable, appears to be best suited for larger game. The support requires straps at both the top and bottom to prevent rotation, which adds to cost, part count, and weight. Furthermore, the support does not offer storage for tools commonly used in preparing game.

U.S. Pat. No. 5,562,534 to McGough discloses a game hoist and skinning aid device. The device includes a support frame for supporting the dead body of animal such as deer and the like in a hoisted position off the ground. Further, the device includes a hand operated winch having a cable. The cable may pass over an upper pulley attached to the support frame to raise the animal carcass into position. The cable may also run through a lower pulley and then attached to the skin of the animal so that operation of the winch provides assistance in skinning the suspended animal carcass. The device disclosed herein may be attached to a tree, post or other vertical object. The McGough device, while effective an excellent solution for hanging large game, is impractical for use with smaller game and fish. The device is large and not intended to be transported. The structure is of a solid form and does not collapse, thus making it impractical for traveling hunters and campers.

U.S. Pat. No. 4,977,643 to Prysock discloses a fish support device. The device is adapted to be used for supporting fish during skinning, scaling or other cleaning operations. More specifically, the device includes a brace support structure with two upper downwardly-angled support arms supporting the outer end of a third horizontal support arm. The inner ends of all three arms are fastened to a vertical support member. Further, a hook suspends from a chain supported by the brace support structure is secured to a mouth or head portion of the fish to suspend the fish for convenient cleaning operations. While the Prysock support intends to be fixed to a tree, it's attachment is more of a permanent one. Bolts, as well as the spikes, must be driven into the tree. This requires additional tools and time.

U.S. Pat. No. 3,199,820 to Thomson discloses a support for hanging fish, game, and the like. The support hanger may be readily attachable to a stable support. Further, the support hanger facilitates the attachment of a fish thereto in such manner that the fish may be rotated about a vertical axis, to make possible cutting open, skinning or cleaning of the fish. More specifically, the support hanger includes an apertured bracket.

The bracket includes an outwardly extending portion thereon. The bracket further includes a second apertured outwardly extending portion. A headed hook is mounted within the aperture in the second outwardly extending portion of the bracket and is supported thereby for rotation of the hook about a vertical axis. The Thomson support is not adapted to be fixed to trees. Rather, it's intent is to be fixed to the same surface with permanent fastening means installed in the surface.

### SUMMARY OF THE INVENTION

In view of the foregoing disadvantages inherent in the known types of game supports now present in the prior art, the present invention provides a new support wherein the same can be utilized for providing convenience for the user when hunting or camping.

It is therefore an object of the present invention to provide a foldable, portable, lightweight support that can be used by hunters and campers to prepare game and hang objects, such as lanterns and trash bags, that must be elevated from the ground. The present invention folds down with the removal of one bolt. The folded size is compact enough to fit into a backpack. Only one strap is required to support the present invention. Two spikes at the base serve to prevent rotation, thus making a second strap unnecessary.

Another object of the present invention is to provide a support that has means for storing commonly used tools in a readily accessible location. The present invention has a magnetic tool support along with a hook on its lower end. The tools can be within arm's reach and can be removed with only one hand. The present invention also incorporates a hook for holding towels on. Towels are commonly required by a hunter when cleaning a carcass. The location of the towel hook ensures that towels are always within reach of the user.

Other objects, features and advantages of the present invention will become apparent from the following detailed description taken in conjunction with the accompanying drawings.

### BRIEF DESCRIPTIONS OF THE DRAWINGS

FIG. 1 Shows a perspective view of the stand attached to a tree with a fish hung for preparation.

FIG. 2 Shows a front view of the towel hook and a cross sectional view of the main support.

FIG. 3 Shows a front view of the base of the stand with the magnetic tool holder.

FIG. 4 Shows a side view of the stand with the extension support attached.

### DETAILED DESCRIPTION OF THE INVENTION

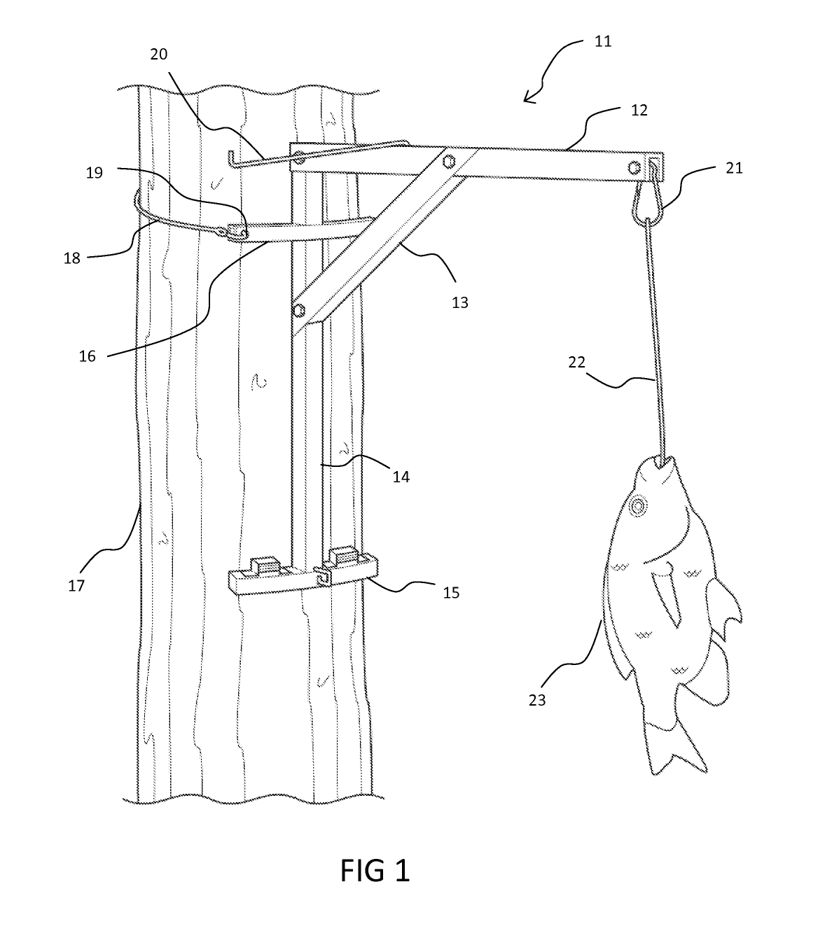

Referring now to FIG. 1, there is shown a perspective view of the stand 11 attached to a tree 17. The stand is intended to be attached to any stationary object, such as a tree, as shown, or other objects, such as a pole. A vertical support 14 rests against the tree 17 and pivotably attaches to a main support 12 with a bolt. An angled support 13 connects the main support 12 with the vertical support 14 near their midsections. The angled support 13 will provide rotational fixity as well as stability to the main support 12. At the upper, first end of the vertical support is an upper curved cross support 16. The cross support 16 is sufficiently curved to conform with the tree 17. At each end of the cross support are holes 19. A strap 18 with hooks at each end wraps around the tree and attaches to each hole 19. The strap 18 can be a ratchet strap, bungee cord, or other similar strap type device that can be tightened to hold the stand on the tree.

At the second end of the main support 12 is a bolt that a hanging hook 21 can be attached to. The hanging hook 21 can be a carbineer, as shown in the figures. A hanger 22 is attached to the hook 21 for hanging an object. The hanger 22 can be a rope, a rigid hook, a chain, or other similar devices. Objects that may be hung can include a small animal or a fish 23, camping lanterns, trash bags, or other commonly used objects that a camper may want to keep elevated.

One of the two bolts that attach the angled support can be removed and the stand collapsed for transport or storage. With a bolt removed, the main support 12 can pivot down, approaching a parallel relationship with the vertical support 14.

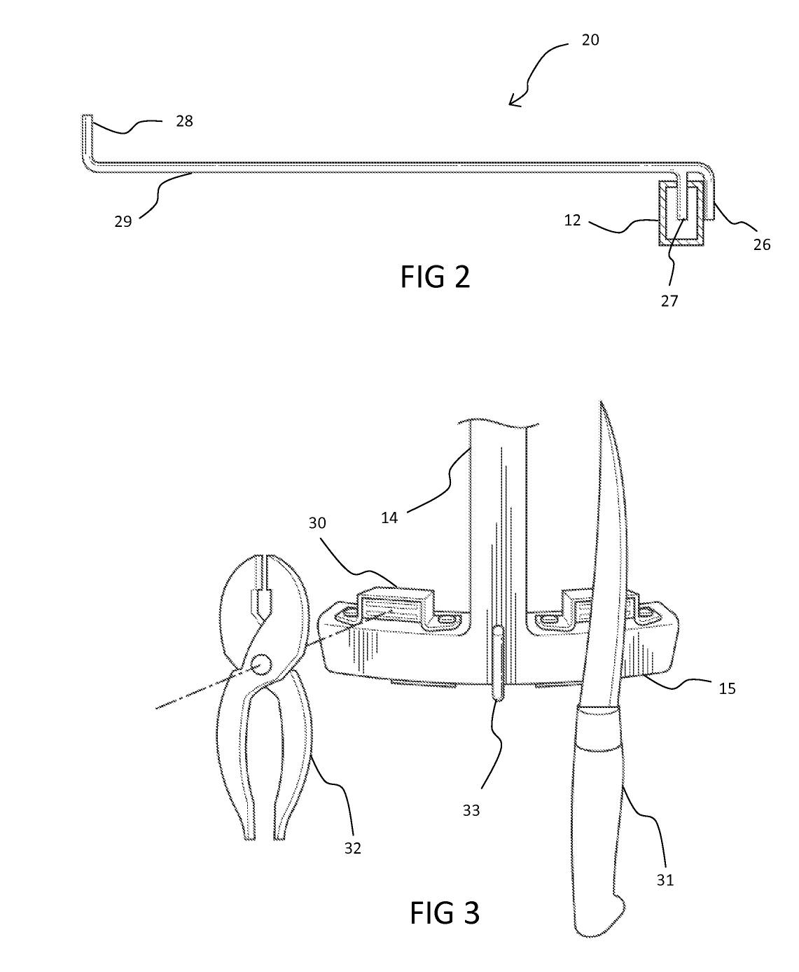

A towel support 20 can be attached to the top surface of the main support 12. FIG. 2 shows a front view of the towel support 20 inserted into a hole on the top surface of the main support 12. The towel support 20 has a straight body 29 with a single hook 28 at its first end and a double hook 26, 27 at its second end. The first hook 27 in the double hook is inserted into the hole in the main support 12. The second hook 26 in the double hook rests against the outer surface of the main support 12 to provide rotational fixity. A single fabric towel can be draped over the support or a roll of paper towels can be attached to the support. The single hook 28 at the first end prevents towels from sliding off. The towel support 20 is lifted out of the main support 12 for transport and storage.

Referring now to FIG. 3, there is shown a frontal view of the lower curved cross support 15. Magnets 30 are attached to the upper surface of the cross support 15. Tools 32,31 are held in place against the magnets so as to be readily accessible and clean. A hook 33 on the front surface of the cross support 15 in between the two magnets 30 can be used to hold additional objects, such as a non-metallic tool, a lantern, or additional garbage bags.

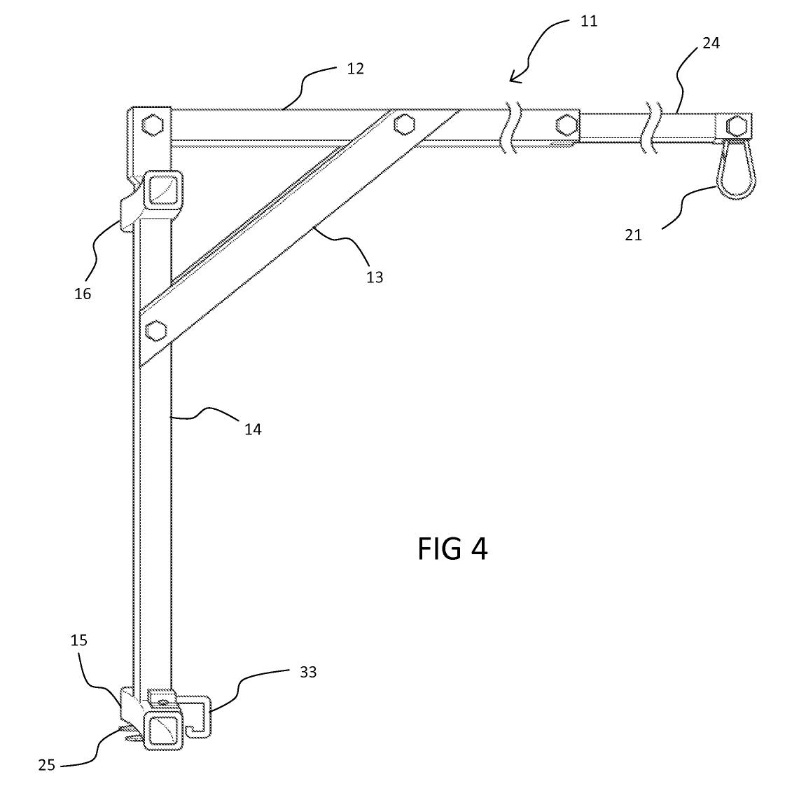

Referring now to FIG. 4, there is shown an alternate embodiment of the stand, wherein an extension support can be attached to the second end of the main support 12. The hanging hook 21 is removed and the extension member 24 is inserted into the second end of the main support 12. The hook 21 is then attached to the second end of the extension support. The extension support is most useful when branches of a tree interfere with using the stand. In this circumstance, the extension support is used to extend the end of the stand out and away from the branches.

In use an individual straps the stand to a tree, pivots the main support up and fastens the angled support. If desired, the extension support can be inserted into the main support. An object is then hung from the hanging hook.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A portable hanging stand for hanging various objects, comprising:
a vertical support, a main support, and an angled support, wherein said vertical support and said main support are pivotably connected at first ends thereon, said angled support being connected at midsections on each of said vertical and main supports, wherein said angled support provides rotational fixity and stability for said main support;
a curved upper cross support integral to said vertical support, wherein said curved upper cross support rests against a stationary object and has a curved contour to conform with said stationary object, said curved upper cross support having a hole in a first and second end, wherein a strap is attached to said holes and wrapped around said stationary object to hold said stand thereto;
a second end of said main support having a hook and hanger attached thereto, wherein an object can be hung from said hanger.

2. The main support of claim 1, wherein an extension support is inserted into said second end in place of said hook and hanger; said extension support having a first end inserted into said second end of said main support and a second end for attaching said hook and said hanger thereto.

3. The hanging stand of claim 1, wherein a towel support having a first end with a single hook and second end with a double hook is attached to said main support.

4. The hanging stand of claim 1, wherein said vertical support has a second end with a lower curved cross support integral thereto, said lower curved support having a first side for resting against said fixed object, wherein spikes protrude from said first side to engage with said fixed object and provide rotational fixity to said stand.

5. The lower curved cross support of claim 4, wherein said support has an upper surface with magnets affixed thereto for holding objects and a front surface with a hook affixed thereto for hanging objects.
